(19) United States
(12) Patent Application Publication
(10) Pub. No.: US 2005/0068442 A1
(43) Pub. Date: Mar. 31, 2005

(54) Presentation system and method of use

(76) Inventors: Corey Billington, San Jose, CA (US); Chris Bradley, Orinda, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/672,999

(22) Filed: Sep. 26, 2003

(51) Int. Cl. H04N 5/222; G03B 21/26

(52) U.S. Cl. 348/333.1; 353/30

(57) ABSTRACT

A system and method for providing a presentation system configured to project an image of an object to a projection surface. The presentation system includes a computer, a digital camera and a digital projector. The computer includes a processor operable to process a digital real-time image. The digital camera is operatively coupled to the computer. The digital camera is oriented toward a desired object to digitally capture a real-time image of the desired object and to transfer the real-time image to the computer to process the real-time image. The digital projector is operatively coupled to the computer. The digital projector is operable to receive the real-time image directly from the computer and to project the real-time image to the projection surface on an enlargeable scale for viewing by one or more viewers.

### FIELD OF THE INVENTION

The present invention relates generally to presentation systems. More particularly, the present invention relates to a presentation system configured to capture and project a real-time image for readily viewing by one or more viewers.

### BACKGROUND OF THE INVENTION

The traditional presentation system is a document projection device that has been in existence since the early 1960's. Such a document projection device is commonly known as an overhead projector and consists typically of a light box and a beam projection apparatus. The light box contains a projection lamp and a top surface of glass. A transparency is placed upon the glass surface and the lamp shines up through the transparency forming an image beam which is collected, focused, and projected by the beam projection apparatus on a screen. The beam projection apparatus generally consists of a mirror diagonally positioned between a pair of lenses.

Such transparency machines are simple in construction, but offer little flexibility for storing, editing or manipulating the images. In order for the image of a document to be clearly visible on the screen, generally the ambient room light must be reduced. This makes it difficult for viewers in the room to also view other documents or materials while the projected document is being viewed.

Another well known presentation system involves preparing digital slides with software and saving such slides in memory on a computer. The computer can then be coupled to a digital projector to project the digital slides onto a screen for viewing in the presentation. Although this type of presentation system works well for many presenters, the presenter does not have the interactive ability of modifying, highlighting and adding comments to the digital slides while the presenter gives such presentation.

Another presentation system known in the art is a stand-alone image capture and projection device. This device uses a high-resolution photo camera with relatively expensive optics for capturing an image, such as a document, and then projects such image onto a screen with a projector integrated with the device. This stand-alone device includes a processor integrated therein to provide its own image rendering and processing capabilities. Although this stand-alone presentation system provides essential components including the camera, projector and the processor all within the stand-alone device, the result is a very costly device for the consumer.

Furthermore, business conferences and meetings often include multiple presenters using different presentation techniques and equipment, which often results in a “shuffle” between presentations and their various types of presentation systems. Typically, the problem is seen where, for example, one presenter is using digital slides in a slide presentation on a laptop computer and projected by a digital projector, and a subsequent presenter is more comfortable with an overhead projector, and another is using the stand-alone image capture and projector device. The delay in changing over from one presentation technology to the next interrupts the flow of the meeting, results in wasted time for all attendees, can cause frustration and annoyance, and in general is presently resented but accepted as necessary to accommodate the preferences of the presenters.

Therefore, there exists a need in the art that allows presenters with various types of presentation formats and techniques that can each readily function in a single type of presentation system that is both user friendly and low in cost.

### SUMMARY OF THE INVENTION

The present invention relates to a method and apparatus for providing a presentation system configured to project an image of an object to a projection surface. The presentation system includes a computer, a digital camera and a digital projector. The computer includes a processor operable to process a digital real-time image. The digital camera is operatively coupled to the computer. The digital camera is operable to be oriented toward a desired object to digitally capture a real-time image of the desired object and is operable to transfer the real-time image to the computer to process the real-time image. The digital projector is operatively coupled to the computer. The digital projector is operable to receive the real-time image directly from the computer and is operable to project the real-time image to the projection surface on an enlargeable scale for viewing by one or more viewers.

### BRIEF DESCRIPTION OF THE DRAWINGS

While the specification concludes with claims particularly pointing out and distinctly claiming that which is regarded as the present invention, the advantages of this invention may be ascertained from the following description of the invention when read in conjunction with the accompanying drawings, in which:

FIG. 1 illustrates a partial perspective and schematic view of a presentation system, depicting a computer system operatively coupled to a digital camera and a projector for projecting a real-time image of an object taken by the digital camera, the digital camera stabilized and oriented by a carrier member, according to an embodiment of the present invention;

FIG. 2 illustrates a top view of the carrier member shown in FIG. 1, depicting the carrier member having the digital camera positioned therewith;

FIG. 3 illustrates a carrier member having a clamp member, according to another embodiment of the present invention;

FIG. 4 illustrates a carrier member having a spring clamp, according to another embodiment of the present invention;

FIG. 5 illustrates a carrier member having a deformable portion, according to another embodiment of the present invention;

FIG. 6 illustrates, in flow chart form, an embodiment by which the presentation system can be implemented by a user; and

FIG. 7 illustrates, in flow chart form, a continuation of FIG. 6 of another embodiment by which the presentation system can be implemented by a user.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

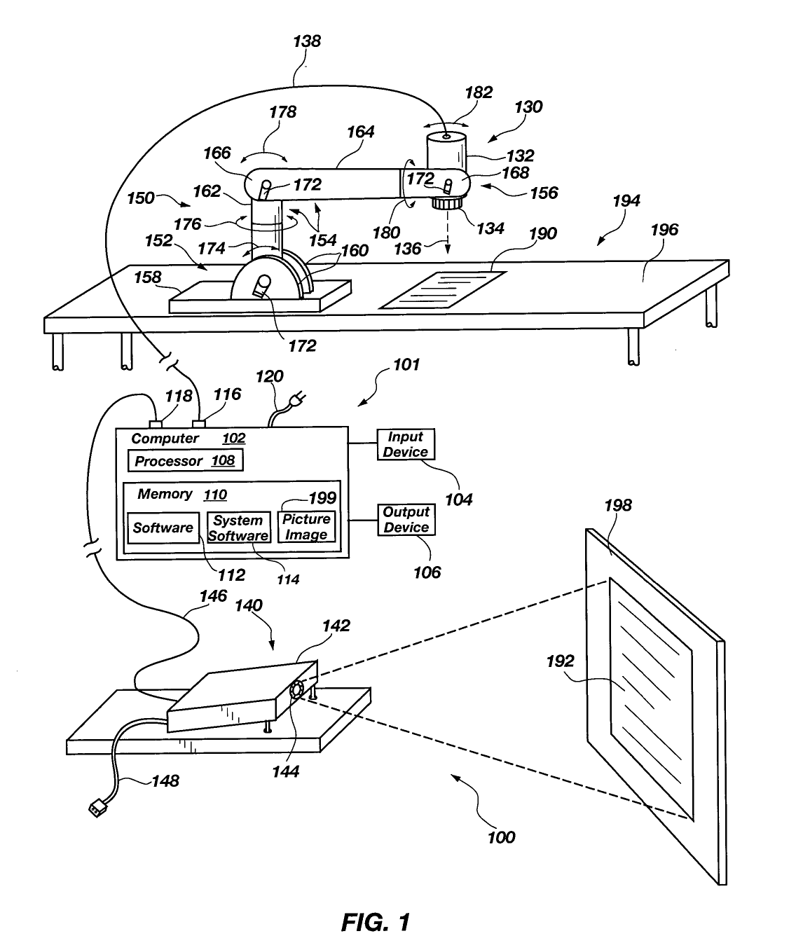

FIG. 1 illustrates a presentation system 100 including a computer system 101, a digital camera 130 and a projector 140, each of which can be bought as separate components. Such a presentation system 100 can be configured to capture a real-time image 192 of a desired object 190 with the digital camera 130 and project such real-time image 192 with the projector 140. The presentation system 100 utilizes the image rendering and processing capabilities of a computer system 101 operatively coupled to the digital camera 130 and projector 140 to result in an inexpensive solution in comparison to currently available presentation systems. Such a presentation system 100 provides that the digital camera 130 can be oriented toward a desired object 190 to digitally capture the real-time image 192 of the desired object 190 and transfer the real-time image 192 to the computer system 101. The computer system 101 processes the real-time image 192 and then transfers the real-time image 192 to the projector 140 configured to project the real-time image 192 onto the projection surface 198. In this manner, the real-time image 192 can be readily viewed on the projection surface 198, in real-time, on an enlargeable scale for readily viewing by one or more viewers.

The presentation system 100 provides versatility to multiple presenters in a meeting that eases the transition time between presenters since most all presentation formats and mediums can be utilized with such presentation system 100. For example, the presentation system 100 can be set-up for a given meeting, which can be configured to capture and project a real-time image of a desired object, such as models, documents, transparencies, etc., as well as allows utilization of digital slides saved to the computer system 101 for transmitting to the projector 140 for projection. Indeed, the presentation system 100 can integrate both the real-time image of, for example, documents and digital slides in the same presentation. With this arrangement, the presentation system 100 can substantially limit the transition time between presenters in a given meeting since the presentation system 100 can be used for most any type of presentation format and/or medium. Further, the presentation system 100 can be intended to be localized in a single on-site location so that each of the digital camera 130, computer system 101 and projector 140 are operatively coupled together within the same on-site location and/or conference room. In this manner, the presenter can have hands-on control over the components of the presentation system 100 during the presentation and the material being presented to the viewers.

The computer system 101 includes a computer 102 coupled to an input device 104 and an output device 106. The computer 102 can be any suitable type of computer means, such as but not limited to, a desk-top computer, a portable computer, a lap-top computer or a personal data assistant. The input device 104 can include a mouse, pointer device, keyboard, touch-sensitive screens or any other suitable input device configured for inputting commands into the computer 102. The output device 106 can include a display screen viewable by the presenter or other user. Such display screen can include a computer monitor, flat screen LCD display, plasma screen or any other suitable display screen operatively coupled to the computer 102.

The computer 102 includes a processor 108 and memory 110 disposed therein. The processor 108 can be formed and configured to process information and images with image rendering capabilities. The memory 110 can include various types of software including operating system software 114. The computer 102 also includes a power cable 120 and various interconnection ports for coupling the computer 102 to external electronic devices. Among such interconnection ports, the computer 102 can include a first port 116 configured to be operatively coupled to the digital camera 130 and a second port 118 configured to be operatively coupled to the projector 140.

In one embodiment, the memory 110 can also include camera software 112 configured to drive and prompt the digital camera 130 and/or the projector 140. The camera software 112 can also be configured to prompt the user through various system functions. For example, the user can view various prompts displayed on the output device 106 and input commands with respect to such prompts through the input device 104. As described in further detail herein, implementation of the various functions of the camera software 112 with the presentation system 100 will be apparent and can be readily prepared by one of ordinary skill in the art. Further, as well known by one of ordinary skill in the art, the software 112 can be embodied on a computer usable medium having a computer readable program code embodied therein.

The digital camera 130 can be a physically separate and discrete electronic component from that of the computer 102. The digital camera 130 can include a camera body 132 and an image capturing lens 134. The digital camera 130 can be a video digital camera, such as but not limited to, the video digital cameras well known in Web cam technology or any other suitable digital camera means configured to capture a digital real-time image as known to a person of ordinary skill in the art. The digital camera 130 also includes a camera cable 138 extending from a portion of the camera body 132. Such a camera cable 138 can be configured to feed and transfer the digitally captured real-time image 192 directly to the computer 102 from the digital camera 130 and can be sized and configured to mate with the first port 116 of the computer 102. In this manner, the digital camera 130 can be operatively coupled to the computer 102. The camera cable 138 and first port 116 of the computer 102 can be a respective USB cable configured to mate with a USB port in the computer 102 or the camera cable 138 can be any suitable camera cable configured to mate with an interconnection port of the computer 102. In another embodiment, the digital camera 130 can be operatively coupled to the computer to transfer the real-time image directly to the computer 102 by way of wireless technology.

The projector 140 can be a physically separate and discrete electronic component from that of the digital camera 130 and the computer 102. The projector 140 can include a projector body 142 and a projector lens 144 with a power cable 148 and a projector cable 146. Such projector cable 146 extends from the projector 140 and can be sized and configured to mate with the second port 118 in the computer 102. The projector cable 146 can be configured to receive the digital real-time image directly from the computer and directly transfer the real-time image to the projector. In this manner, the projector 140 is operatively coupled to the computer by way of the projector cable 146. Such projector cable 146 can be a VGA cable configured to mate with a VGA port in the computer 102 or any other suitable mating connection configured for transferring digital real-time images to the projector 140 directly from the computer 102. In another embodiment, the projector 140 can also receive the real-time images directly from the computer 102 by wireless technology. The projector 140 can be any suitable digital projector means configured to receive and project a digitally captured real-time image, such as digital light processing projectors, or any other suitable digital projector known in the art.

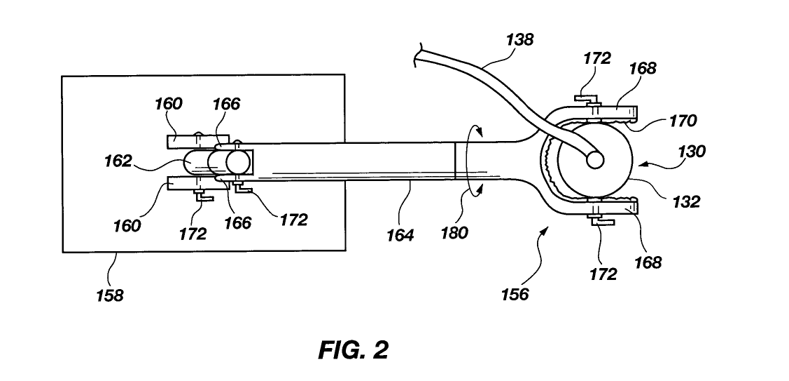

Referring now to FIGS. 1 and 2, the digital camera 130 can be stabilized, positioned and/or oriented with a carrier member 150 or any other suitable stabilizing means known by one of ordinary skill in the art. Such a carrier member 150 can include a base portion 152 and a camera mount portion 156 with an extension member 154 extending therebetween. The base portion 152 can include a platform 158 and base couplings 160. The platform 158 can be a weighted down rectangular member or any suitable shape for stabilizing the carrier member 150 and thus, the digital camera 130. As such, the platform 158 can be sized and configured to stabilize the carrier member 150 so that the real-time image 192 captured by the digital camera 130 can be substantially motionless and can be readily viewed by viewers.

The base coupling 160 can be formed and configured to couple with the extension member 154. As depicted, the base coupling 160 can include two extensions mounted to an upper surface of the platform 158 and spaced to sandwich the extension member 154 therebetween and held together with any suitable fastener, such as a bolt and tightening member 172. Such bolt and tightening member 172 arrangement can allow the extension member 154 to pivot, as indicated by arrow 174, to a desired orientation and to be secured in the desired orientation by the tightening member 172. It should be noted that the base coupling 152 can take on other forms to pivotably couple the extension member 154 to the platform 158, such as the base coupling 152 including a ball and socket arrangement that allows rotation and includes a pivot arm for tightening the ball and socket position.

The extension member can include one or more portions, such as, a vertical or lower extension 162 and a horizontal or upper extension 164. The lower extension 162 can be a tubular member with one end pivotably coupled, as previously described, to the base coupling 160. The second end of the lower extension can be pivotably coupled to the upper extension 164. The lower extension 162 can also include two tubular members coupled longitudinally together with, for example, an interference fit to allow a controlled rotation, as indicated by arrow 176. The upper extension 164 can include extension arms 166 extending longitudinally from one end thereof for coupling with the lower extension 162. Such a coupling can be employed with, for example, a bolt and tightening member 172 so as to facilitate the upper extension 164 to pivot about the coupling between the upper extension 164 and lower extension 162 as indicated by pivot arrow 178. At the second end, opposite to the coupling with the lower extension 162, the upper extension 164 can be coupled to the camera mount portion 156. Such coupling can include a configuration so that the camera mount portion 156 can be rotatable with respect to the upper extension 164 as indicated by arrow 180.

The camera mount portion 156 can include camera mount arms 168 extending outward from one end thereof. Such camera mount arms 168 are sized and configured to receive and hold the camera body 132. The camera mount arms 168 can include a padding 170 attached to the inner surface of the camera mount arms 168 configured to hold and protect the digital camera 130 within the camera mount arms 168. In addition, the camera mount portion 156 can include tightening members 172 extending through each of the camera mount arms 168 configured to be rotatably tightened and loosened to hold the digital camera 130 within the camera mount portion 156 and positioned at a desired orientation, as indicated by arrow 182. With this arrangement, the various components of the carrier member 150 can be pivoted and rotated by loosening and tightening the tightening members 172 so that the digital camera 130 can be stabilized and positioned in a desired orientation. It should be noted that the above-described embodiment of the carrier member 150 is only provided for illustrative purposes and that it will be apparent to one of ordinary skill in the art that numerous modifications can be made without departing from the principles and concepts of the present invention.

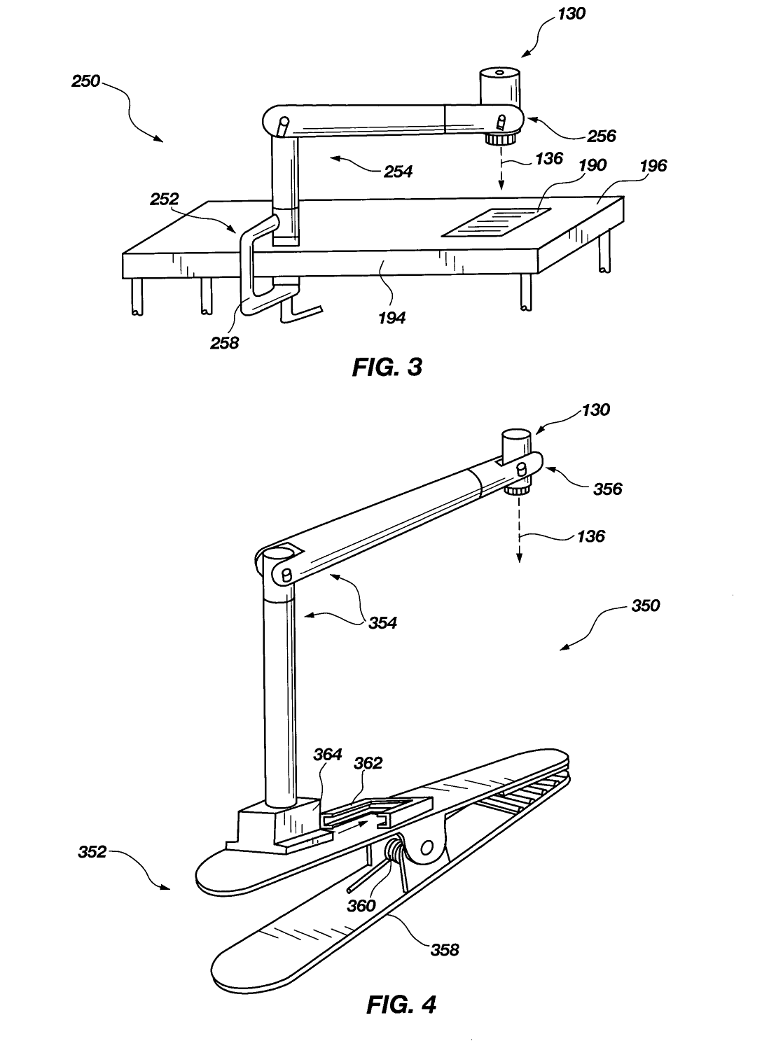

For example, referring now to FIG. 3, there is illustrated another embodiment of a carrier member 250. This carrier member 250 can be substantially the same as the carrier member in the previous embodiment described in FIGS. 1 and 2, except the base portion 252 of this embodiment includes a clamp member 258. Such clamp member 258 can be coupled to the extension member 254 with, for example, a base holder 362 and a base attachment 364 with a sliding interference-type fit or any other suitable coupling means known to one of ordinary skill in the art. The clamp member 258 can be sized and configured to clamp onto a stabilized surface or object 194 (FIG. 3), such as a table or the like having a writing surface 196. In this manner, the extension member 254 extends upward and over the writing surface 196 on which an object 190, such as a document, can be positioned within the orientation direction 136 and field-of-view of the digital camera 130.

With respect to FIG. 4, another embodiment of a carrier member 350 is illustrated. This embodiment of the carrier member 350 can be substantially similar to the carrier member described in FIG. 3, except the base portion 352 includes a spring clamp 358. Such a spring clamp 358 can include a spring portion 360 integrated therein so that the spring clamp 358 can be sized and configured to clamp to a stabilized object 194, such as a table, a lap-top computer screen, and/or the projector, or any other suitable stabilized object.

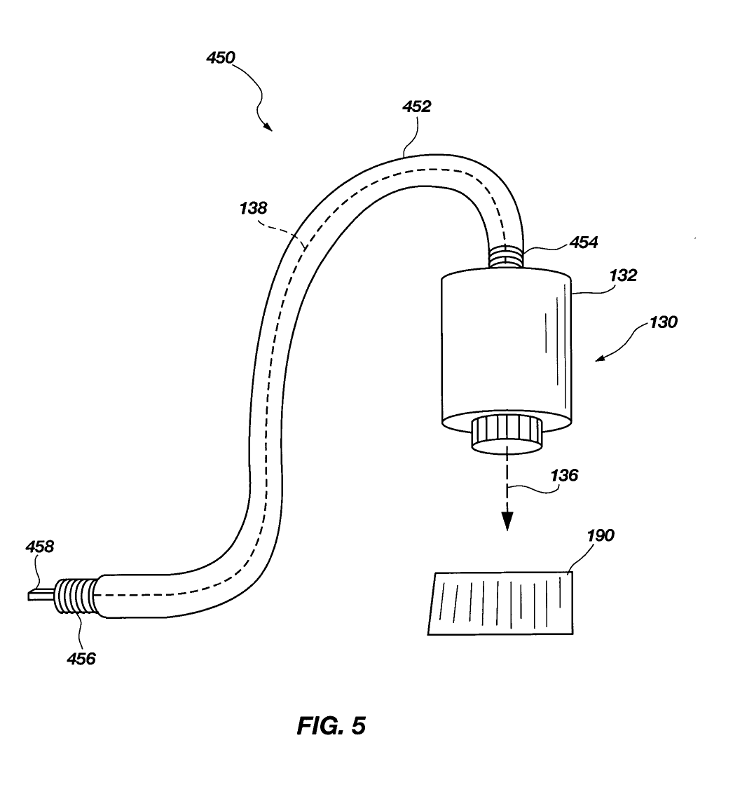

With respect to FIG. 5, another embodiment of a carrier member 450 for the digital camera 130 is illustrated. In this embodiment, the carrier member 450 can be integrally formed with an electrical coupling or a connector portion 458. The connector portion 458 can be electrically coupled to the digital camera with the camera cable 138 (shown in outline). Further, the digital camera 130 can be integrated with the carrier member 450. Such a carrier member 450 can include a deformable portion 452 formed around the camera cable 138. The deformable portion 452 can include a flexible material that allows easy manual movement of the carrier member to a desired orientation and position that maintains such orientation and position. The carrier member 450 can include a base strain relief 456 and a camera strain relief 454 at each opposing end of the deformable portion 452. The base strain relief 456 can be coupled to the connector portion 458 configured to directly mate with the first port 116 (FIG. 1) of the computer. The camera strain relief 454 can be molded directly to the camera body 132 of the digital camera 130 or to a covering molded around the digital camera 130. In this manner, the carrier member 450 of this embodiment can be integrated and formed with the digital camera 130.

With reference to FIGS. 1, 3, 4 and 5, each carrier member 150, 250, 350 and 450 can be manipulated to position the digital camera 130 to capture a digital real-time image 192 in a desired orientation direction 136. The orientation direction 136 can be the direction by which the digital camera 130 digitally captures a real-time image 192 within an area or field-of-view. As such, an object 190 can be placed in the field-of-view of the orientation direction 136 to capture a real-time image 192 of the object 190. As previously set forth, the real-time image 192 can then be transferred from the digital camera 130 to the computer 102 via the camera cable 138 for processing and then transferred to the projector 140 via the projector cable 146. The projector 140 then projects such real-time image 192 of the object 190 onto a projection surface 198. The object 190 placed in the field-of-view of the orientation direction 136 of the digital camera 130 can be a document, a three-dimensional object and/or a computer screen or any other suitable object that the user desires to display, in real-time, on the projection surface 198 for viewing by one or more viewers in, for example, a business conference.

Furthermore, in the case the object 190 is a three-dimensional object that the user wishes to project in real-time on the projection surface 198. The user can readily point to various features of the three-dimensional object while discussing such features. As such, the viewers gain a greater appreciation and understanding of the information being conveyed by the presenter. In the case the object 190 is a document, photograph, or the like, the user can modify the document with writing indicia during the presentation of the user. Such modifications are viewable in real-time with the real-time image 192 projected on the projection surface 198. At any given time during the presentation, the user can take a digital picture image 199 of the modified document. Such digital picture 199 can then be saved in the memory 110 on the computer 102 and later disseminated to the viewers electronically by, for example, email or the user can later print a hard-copy of the saved picture image 199 and provide such hard-copy to the viewers.

In another embodiment, the camera software 112 can be configured to allow electronic modifications, such as writing indicia and/or highlighting indicia, directly to the real-time image displayed on the output device 106 and displayed on the projection surface 198 by inputting commands with the input device 104 to the computer 102. As previously set forth, such modified real-time image can be captured as a picture image 199 and saved to the memory 110 of the computer 102.

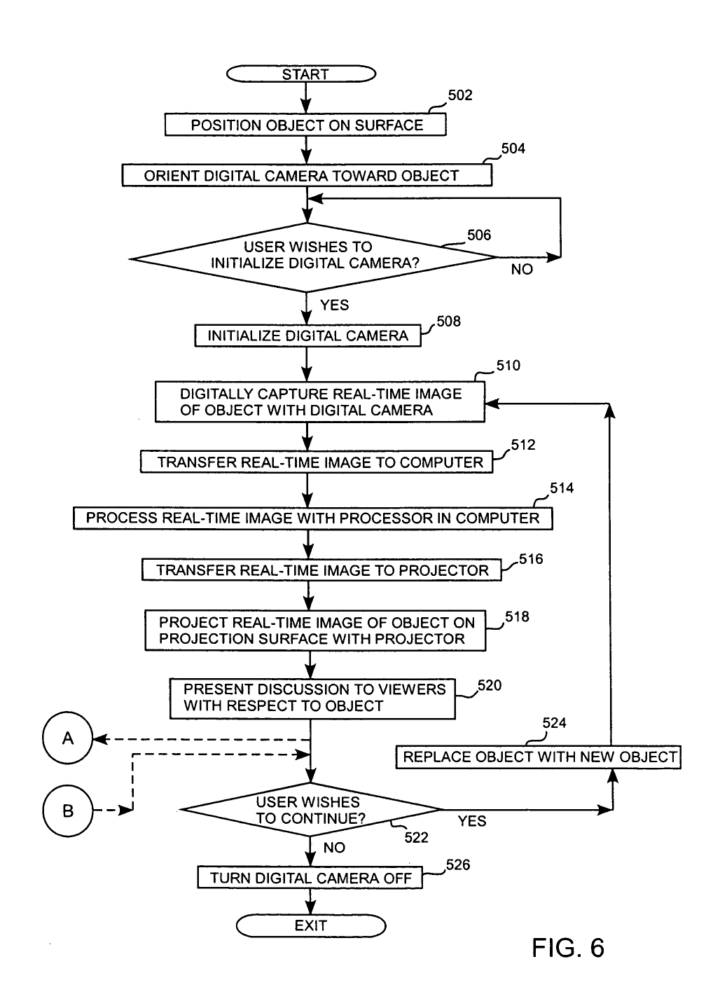

To better illustrate the functionality of the present invention, FIG. 6 illustrates a flow diagram of an embodiment by which the presentation system 100 can be employed by a user. With reference to FIGS. 1 and 6, as indicated in block 502, a user of the presentation system 100 can position an object 190 on, for example, a writing surface 196 or stabilized object 194, such as a desk. The user can then orient the digital camera 130 so that the orientation direction 136 of the digital camera 130 is directed toward the object 190 on the writing surface 196, as indicated in block 504. Such orienting of the digital camera 130 can be accomplished by manipulating the carrier member 150 holding the digital camera 130, as indicated in block 504. It should be noted that a user may first position the carrier member 150 so that the digital camera 130 is in a desired orientation and then position the object 190 in line with the orientation direction 136 of the digital camera 130. As previously indicated, the object 190 can be a document, a three-dimensional object and/or a computer screen, or any other suitable object the user wishes to display and present to one or more viewers.

At this juncture, the user can choose whether to initialize the digital camera 130, as indicated in user decision block 506. Once the user is ready to proceed with the presentation, the user can initialize the digital camera 130 through the camera software 112 by inputting commands in the computer 102 through the input device 104 and/or manually turning on the digital camera 130, as indicated in block 508. The digital camera 130 then digitally captures a real-time image 192 of the object 190, as indicated in block 510. The real-time image 192 can then be transferred from the digital camera 130 to the computer 102, as indicated in block 512. The computer 102 then processes the real-time image 192 with a processor 108 in the computer 102, as indicated in block 514. The real-time image 192 of the object 190 can then be transferred from the computer 102 to the projector 140, as indicated in block 516. The real-time image 192 of the object 190 can then be projected by the projector 140 onto a projection surface 198 on an enlargeable scale readily viewable by one or more viewers, as indicated in block 518. If desired, the user can re-position the object 190, re-orient the digital camera 130 and/or manipulate the projector 140 to obtain the desired real-time image 192 on the projection surface 198. The user can then proceed in presenting a discussion to the viewers with respect to the given object 190, as indicated in block 520.

Once the user has finished the presentation with respect to the object 190 being displayed in real-time on the projection surface 198, the user can choose whether to continue, as indicated in user decision block 522. If the user wishes to continue, the user can proceed by, for example, replacing the object 190 with a new object, as indicated in block 524. Once the object has been replaced with a new object, the digital camera 130 then digitally captures a real-time image 192 of the new object, of which the real-time image 192 goes through the previously described process to project the real-time image 192 of the new object onto the projection surface 198, as indicated in blocks 510 through 518. The user can then proceed in providing a presentation with respect to the new object, as indicated in block 520. At user decision block 522, once the user has completed the presentation with respect to the object 190 being displayed in real-time on the projection surface 198, the user can choose to discontinue by turning the digital camera 130 off, as indicated in block 526. Such may be accomplished through the camera software 112 by inputting commands with the input device 104 of the computer 102 and/or by simply turning the digital camera 130 off manually.

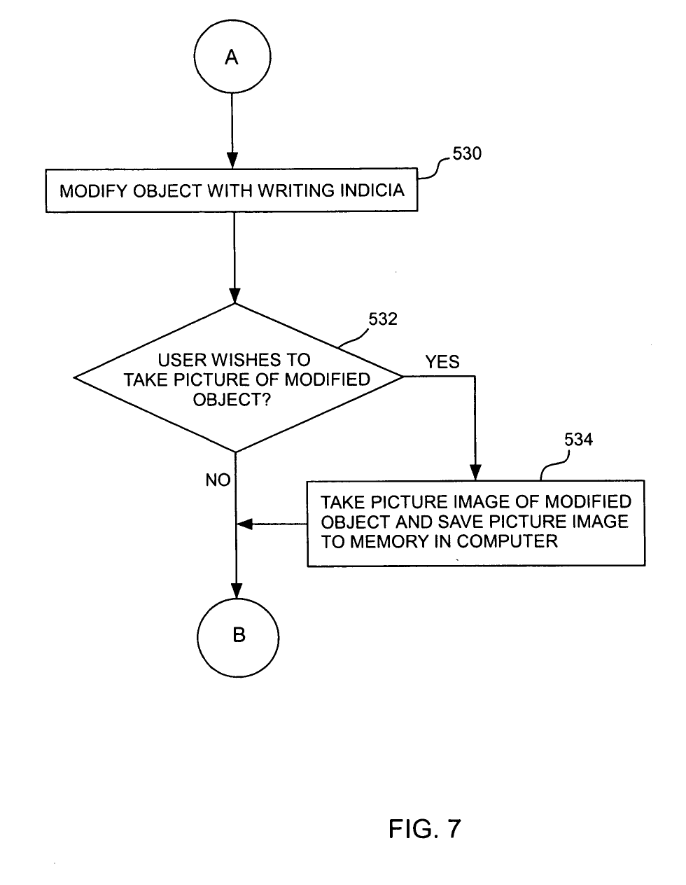

FIG. 7 illustrates another embodiment by which the presentation system 100 can be implemented by a user during or after, for example, a user is providing a presentation to viewers as indicated in block 520 (FIG. 5). With reference to FIGS. 1 and 7, during the presentation of the real-time image 192 of the object 190, such as a document, the user can modify the object 190 with writing indicia, as indicated in block 530. The writing indicia, such as notes, explanations, comments etc., can be written directly on the object 190 while being displayed in real-time on the projection surface 198 as the real-time image 192. In another embodiment, the user can electronically modify the real-time image through the camera software 112 with writing indicia and/or highlighting indicia by inputting commands with the input device of the computer system 101. In either case, once the user has completed the presentation with respect to the particular object 190 being displayed, the user can choose whether to take a picture image 199 of the object 190 with the modifications thereto, as indicated in user decision block 532. If the user desires to take a picture image 199, the user can take a picture image 199 of the modified object 190 which can be saved to the memory 110 in the computer 102, as indicated in block 534. Such can be accomplished through a user interface provided by the camera software 112 on the computer 102 by inputting commands and prompting the digital camera 130 to take a picture image 199 of the object 190. Once the user has taken the picture image 199, the user can proceed to user decision block 522 and proceed as previously set forth. Likewise, if the user chooses not to take a picture image of the modified object, the user can proceed to user decision block 522 and continue by either turning the digital camera 130 off, as indicated in block 526 or by replacing the object with a new object as previously set forth in block 524 and illustrated in FIG. 6.

It is to be understood that the above-referenced arrangements are only illustrative of the application for the principles of the present invention. Numerous modifications and alternative arrangements can be devised without departing from the spirit and scope of the present invention while the present invention has been shown in the drawings and fully described above with particularity and detail in connection with what is presently deemed to be the most practical and preferred embodiments(s) of the invention, it will be apparent to those of ordinary skill in the art that numerous modifications can be made without departing from the principles and concepts of the invention as set forth in the claims.

1. A method of displaying a digital real-time image of an object to one or more viewers, the method comprising:
positioning the object on a substantially flat writing surface;
orienting a digital camera toward the object on the substantially flat writing surface;
digitally capturing a real-time image of the object with the digital camera;
transferring said real-time image to a computer operatively coupled to said digital camera;
processing said real-time image with a processor in said computer;
transferring said real-time image from said computer directly to a digital projector operatively coupled to said computer; and
projecting said real-time image of the object on a projection surface with the digital projector.

2. The method of claim 1, further comprising the step of modifying the object with writing indicia while projecting said real-time image with modifications to the object.

3. The method of claim 2, further comprising the step of digitally taking a picture image of the real-time image with modifications to the object.

4. The method of claim 3, further comprising the step of saving said picture image to memory in said computer.

5. The method of claim 4, wherein said digitally taking said picture image comprises prompting said digital camera through camera software loaded on said computer to undergo said taking said picture image.

6. The method of claim 1, wherein said orienting said digital camera comprises moving an extension member operatively coupled to said digital camera to a desired position to obtain said orienting of said digital camera.

7. The method of claim 1, wherein said digitally capturing comprises prompting the digital camera through camera software loaded on said computer to undergo said digitally capturing.

8. An article of manufacture, comprising:
a computer usable medium having computer readable program code embodied therein for displaying a digital real-time image of an object to one or more viewers, the computer readable program code in the article of manufacture comprising:
computer readable program code for implementing a presentation system from a computer operatively coupled to a digital camera and a digital projector;
computer readable program code for directly receiving a real-time image captured by the digital camera for processing the real-time image on the computer; and
computer readable program code for directly transferring the real-time image to the digital projector for projecting the real-time image to a projection surface on an enlargeable scale for viewing by one or more viewers.

9. The article of manufacture of claim 8, further comprising computer readable program code for modifying the real-time image with writing indicia while projecting said real-time image with modifications to the object.

10. The article of manufacture of claim 9, further comprising computer readable program code for digitally taking a picture image of the real-time image with modifications thereto.

11. The article of manufacture claim 10, further comprising computer readable program code for saving said picture image to memory in said computer.

12. A presentation system configured to project an image of an object to a projection surface, the presentation system comprising:
a computer having a processor operable to process a digital real-time image;
a digital camera operatively coupled to said computer, said digital camera operable to be oriented toward a desired object to digitally capture a real-time image of the desired object and operable to transfer said real-time image to said computer to process said real-time image; and
a digital projector operatively coupled to said computer, said digital projector operable to receive said real-time image directly from said computer and operable to project said real-time image to the projection surface on an enlargeable scale for viewing by one or more viewers.

13. The presentation system of claim 12, further comprising a camera carrier having a base portion and a camera mount portion, said base portion operable to stabilize said camera carrier and said camera mount portion operable to removably mount said digital camera thereto.

14. The presentation system of claim 13, further comprising an extension member positioned between said base portion and said camera mount portion and operable to orient and position said digital camera to digitally capture said real-time image of the desired object.

15. The presentation system of claim 13, wherein said base portion comprises a platform member operable to sit on a flat surface to stabilize said camera carrier.

16. The presentation system of claim 13, wherein said base portion comprises a clamping member operable to clamp to a stabilized object to stabilize said digital camera.

17. The presentation system of claim 16, wherein said clamp member comprises a spring clamp.

18. The presentation system of claim 12, wherein said computer includes memory having camera software loaded thereon, said camera software operable to digitally capture a picture image from said real-time image of the desired object to be saved in said memory.

19. The presentation system of claim 12, wherein said computer is selected from the group consisting of a portable computer, a desk-top computer and a personal data assistant.

20. The presentation system of claim 12, further comprising a camera carrier integrally formed with an electrical coupler operable to couple with the computer, the camera carrier being operatively coupled to said digital camera and formed from a flexible material operable to positionably orient and substantially stabilize the digital camera in a desired orientation.

21. The presentation system of claim 12, wherein said computer includes image rendering ability to digitally receive and process said real-time image and transfer said real-time image to said digital projector.

22. The presentation system of claim 12, wherein said digital camera comprises a digital video camera.

23. A presentation system configured to project an image of an object to a projection surface, comprising:
computer means for processing a digital real-time image;
digital camera means operatively coupled to said computer means, said digital camera means operable to be oriented toward a desired object to digitally capture a real-time image of the desired object to transfer said real-time image to said computer means for processing said real-time image; and
digital projector means operatively coupled to said computer means, said digital projector means operable to receive said real-time image directly from said computer means to project said real-time image to the projection surface on an enlargeable scale for viewing by one or more viewers.

24. The projecting system means of claim 23, further comprising stabilizing means for stabilizing said digital camera means capturing the real time image.
